(19) United States
(12) Patent Application Publication
(10) Pub. No.: US 2012/0006295 A1
(43) Pub. Date: Jan. 12, 2012

(54) ENGINE ASSEMBLY INCLUDING ASYMMETRIC EXHAUST VALVE CONFIGURATION

(75) Inventors: ALAN W. HAYMAN, ROMEO, MI (US); ERIC C. DOUSE, BLOOMFIELD HILLS, MI (US); ROBERT S. MCALPINE, LAKE ORION, MI (US)

(73) Assignee: GM GLOBAL TECHNOLOGY OPERATIONS, INC., DETROIT, MI (US)

(21) Appl. No.: 12/834,467

(22) Filed: Jul. 12, 2010

(51) Int. Cl. F02F 1/42

(52) U.S. Cl. 123/193.5

(57) ABSTRACT

An engine assembly may include an engine structure, a first valve and a second valve. The engine structure may define a combustion chamber and first and second exhaust ports in communication with the combustion chamber. The first valve may be arranged within the first exhaust port and have a first surface area. The second valve may be arranged within the second exhaust port and have a second surface area greater than the first surface area.

### FIELD

The present disclosure relates to an engine assembly, and more specifically to an engine cylinder with an asymmetric valve configuration.

### BACKGROUND

This section provides background information related to the present disclosure which is not necessarily prior art.

An engine assembly may include an engine block that defines a plurality of cylinders. Each cylinder may be in communication with a fuel system, an intake manifold through at least one intake valve and an exhaust manifold through at least one exhaust valve. The size of the intake and exhaust valves, among other factors, affects engine operation. As the size of a cylinder bore becomes smaller, however, the size of each of the valves may also become correspondingly smaller. Thus, the valve size of a smaller bore engine may be limited by the space available within a cylinder.

### SUMMARY

This section provides a general summary of the disclosure, and is not a comprehensive disclosure of its full scope or all of its features.

An engine assembly may include an engine structure, a first valve and a second valve. The engine structure may define a combustion chamber and first and second exhaust ports in communication with the combustion chamber. The first valve may be arranged within the first exhaust port and have a first surface area. The second valve may be arranged within the second exhaust port and have a second surface area greater than the first surface area.

A cylinder head may include a combustion chamber surface that defines a first exhaust port and a second exhaust port. The first exhaust port may have a first cross-sectional area and the second exhaust port may have a second cross-sectional area greater than the first cross-sectional area.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only and are not intended to limit the scope of the present disclosure in any way.

FIG. 1 is a schematic illustration of an engine assembly according to the present disclosure;

FIG. 2 is a schematic section view of the engine assembly of FIG. 1; and

FIG. 3 is a partial section view of a cylinder head and combustion chamber of the engine assembly of FIGS. 1-2.

Corresponding reference numerals indicate corresponding parts throughout the several views of the drawings.

### DETAILED DESCRIPTION

Examples of the present disclosure will now be described more fully with reference to the accompanying drawings. The following description is merely exemplary in nature and is not intended to limit the present disclosure, application, or uses.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on,” “engaged to,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

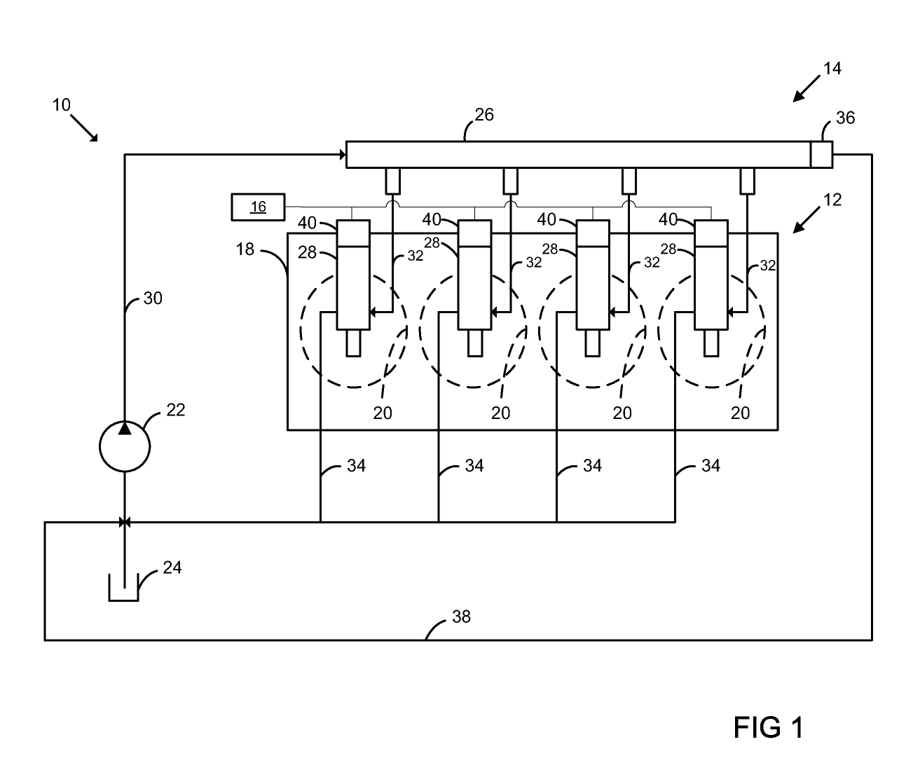

Referring to FIG. 1, an exemplary engine assembly 10 is schematically illustrated. The engine assembly 10 may include an engine structure 12 in communication with a fuel system 14 and a control module 16. In the example shown, the engine 12 may include an engine block 18 that defines a plurality of cylinders 20 in communication with the fuel system 14. While the engine 12 is illustrated as a four cylinder engine in the present disclosure it is understood that the present teachings apply to a variety of engine configurations and is in no way limited to the configuration shown.

The fuel system 14 may include a fuel pump 22, a fuel tank 24, a fuel rail 26, fuel injectors 28, a main fuel supply line 30, secondary fuel supply lines 32 and fuel return lines 34. The fuel pump 22 may be in communication with the fuel tank 24 and may provide a pressurized fuel supply to the fuel rail 26 via the main fuel supply line 30. The fuel rail 26 may provide the pressurized fuel to injectors 28 via the secondary fuel supply lines 32. The fuel rail 26 may include a pressure regulating valve 36 that regulates fuel pressure within the fuel rail 26 by returning excess fuel to the fuel tank 24 via a return line 38.

The fuel injectors 28 may each include an actuation assembly 40 in communication with the control module 16. In the present non-limiting example, the fuel injectors 28 may form direct injection fuel injectors where fuel is injected directly into the cylinders 20. The fuel injectors 28 may return excess fuel to the fuel tank 24 via the fuel return lines 34.

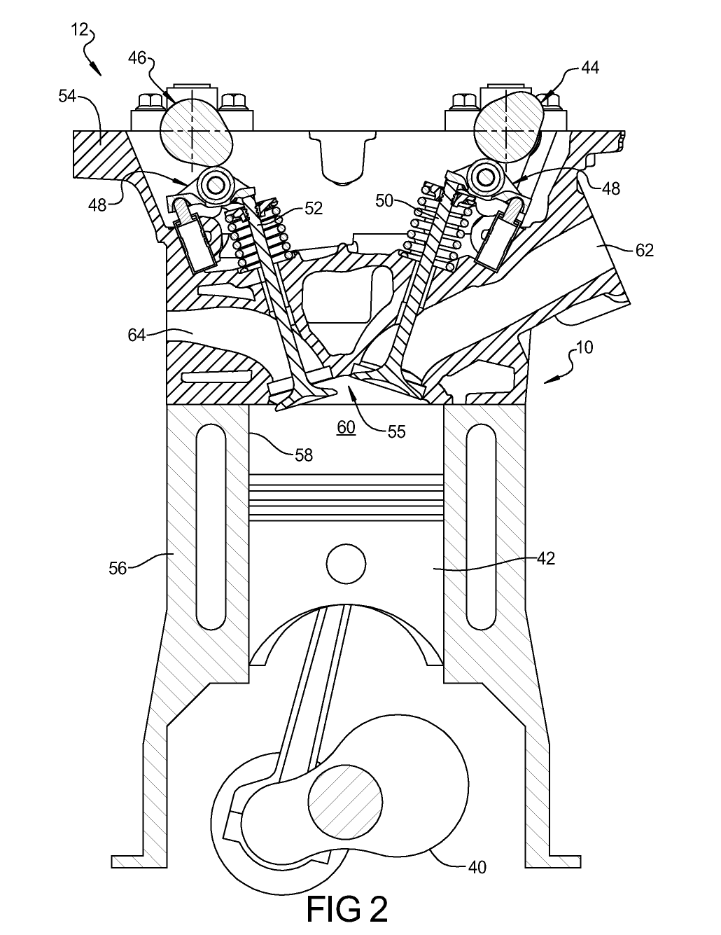

With additional reference to FIG. 2, the engine assembly 10 may include an engine structure 12, a crankshaft 40 rotationally supported by the engine structure 12, pistons 42 coupled to the crankshaft 40, intake and exhaust camshaft assemblies 44, 46 rotationally supported on the engine structure 12, valve lift assemblies 48, at least one intake valve 50 and at least one exhaust valve 52. In the present non-limiting example, the engine assembly 10 is shown as a dual overhead camshaft engine with the engine structure 12 including a cylinder head 54 rotationally supporting the intake and exhaust camshaft assemblies 44, 46 and an engine block 56 defining cylinder bores 58. It is understood, however, that the present disclosure is not limited to overhead camshaft configurations.

The pistons 42 may be disposed within the combustion chambers 60. The cylinder head 54, the engine block 56 and the pistons 42 may cooperate to define combustion chambers 60. The cylinder head 54 may include a combustion chamber surface 55 that defines at least one intake port 62 and at least one exhaust port 64 for each combustion chamber 60. The intake valve(s) 50 may open and close the intake port(s) 62 and the exhaust valve(s) 52 may open and close the exhaust port(s) 64. The valve lift assemblies 48 may be engaged with the intake camshaft assembly 44 and the intake valve(s) 50 to open the intake port(s) 62. Further, the valve lift assemblies 44 may be engaged with the exhaust camshaft assembly 46 and the exhaust valve(s) 52 to open the exhaust port(s) 64.

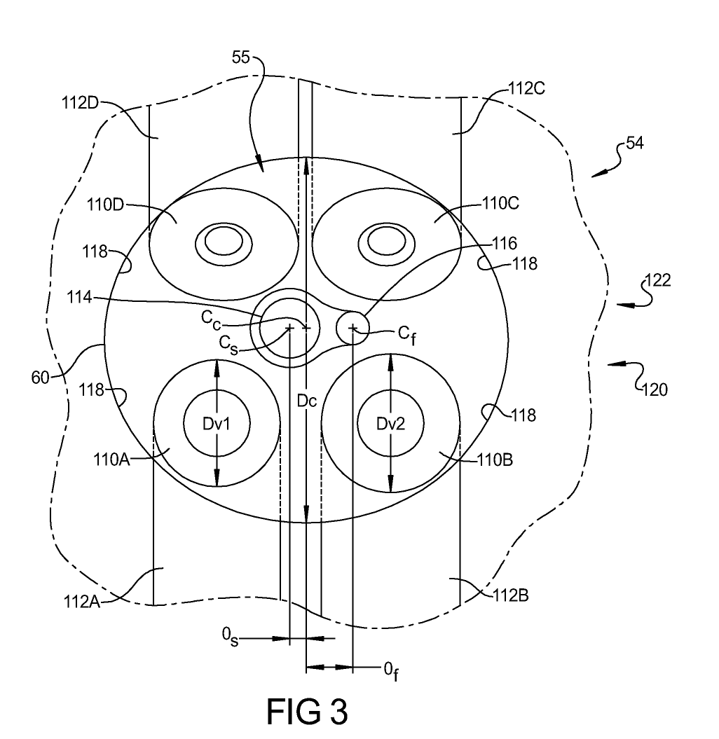

Referring to FIG. 3, a partial sectional view of an exemplary cylinder head 54 and combustion chamber 60 according to the present disclosure is illustrated. In a non-limiting example, the combustion chamber 60 may have a circular (or oval) shape and a diameter D_{c}. A plurality of circular (or oval) valves, such as first valve 110A, second valve 110B, third valve 110C and fourth valve 110D, may be in communication with the combustion chamber 60. Each of these valves 110A-D may be arranged within a corresponding port 112A-D, i.e., first valve 110A may be arranged within first port 112A, second valve 110B may be arranged within second port 112B, third valve 110C may be arranged within third port 112C, and fourth valve 110D may be arranged within fourth port 112D.

Each of the valves 110A-D may have a corresponding surface area and diameter (first valve 110A may have a first surface area Aᵥ₁ and a first diameter Dᵥ₁, second valve 110B may have a second surface area Aᵥ₂ and a second diameter Dᵥ₂, third valve 110C may have a third surface area Aᵥ₃ and a third diameter Dᵥ₃, fourth valve 110D may have a fourth surface area Aᵥ₄ and a fourth diameter Dᵥ₄). Similarly, each of the ports 112A-D may have a corresponding cross-sectional area and diameter (first port 112A may have a first cross-sectional area Aₚ₁ and a first diameter Dₚ₁, second port 112B may have a second cross-sectional area Aₚ₂ and a second diameter Dₚ₂, third port 112C may have a third cross-sectional area Aₚ₃ and a third diameter Dₚ₃, fourth port 112D may have a fourth cross-sectional area Aₚ₄ and a fourth diameter Dₚ₄). As described above, each of the valves 110A-D may open and close its corresponding port 112A-D during operation of the engine assembly 10.

The combustion chamber surface 55 of the cylinder head 54 may include a spark plug boss 114 and a fuel injector boss 116. A spark plug (not shown) may be arranged within the spark plug boss 114 and a fuel injector 28 may be arranged within the fuel injector boss 116. As illustrated in FIG. 3, the spark plug boss 114 and fuel injector boss 116 may be arranged centrally on the combustion chamber surface 55. In this manner, the valves 110A-D may be arranged between the walls of the combustion chamber 60 (cylinder wall 118) and the spark plug and fuel injector bosses 114, 116.

In the illustrated example of FIG. 3, the first valve 110A and fourth valve 110D are each arranged between the spark plug boss 114 and cylinder wall 118, while the second valve 110B and third valve 110C are each arranged between the fuel injector boss 116 and cylinder wall 118. The combustion chamber surface 60 (and combustion chamber surface 55) may be divided into and include a first portion 120 and second portion 122. In a non-limiting example, the first portion 120 may include the first valve 110A and the second valve 110B and the second portion 122 may include the third valve 110C and the fourth valve 110D. The spark plug boss 114 and fuel injector boss 116 may be arranged between the first portion 120 and the second portion 122.

The exact placement of the spark plug and fuel injector bosses 114, 116 may vary even when being arranged centrally on the combustion chamber surface 55. By way of non-limiting example, the spark plug boss 114 may have a first center point Cₛ that may be offset from a third center point C_{c} of the combustion chamber surface 55 by a first offset Oₛ. Further, the fuel injector boss 116 may have a second center point C_{f} that may be offset from the third center point C_{c} of the combustion chamber surface 55 by a second offset O_{f}. Because the spark plug boss 114 may be larger than the fuel injector boss 116, the second offset O_{f} may be greater than the first offset Oₛ. In this manner, the first valve 110A and the first center point Cₛ of the spark plug boss 114 may be present on a first side of the combustion chamber 60 and combustion chamber surface 55. Further, the second valve 110B and the second center point C_{f} of the fuel injector boss 116 may be present on a second side that is opposite the first side of the combustion chamber 60 and combustion chamber surface 55.

In a non-limiting example, the first valve 110A and the second valve 110B may comprise exhaust valves (such as exhaust valves 52) and the first port 112A and the second port 112B may comprise first and second exhaust ports (such as exhaust ports 64). The third valve 110C and the fourth valve 110D may comprise intake valves (such as intake valves 50) and the third port 112C and the fourth port 112D may comprise intake ports (such as intake ports 62). In this example, as shown in FIG. 3, the first portion 120 may include the exhaust valves 52 (first valve 110A and second valve 110B) and exhaust ports 64 (first port 112A and second port 112B) and the second portion 122 may include the intake valves 50 (third valve 110C and fourth valve 110D) and intake ports 62 (third port 112C and fourth port 112D).

The size of the valves 110A-D and ports 112A-D may be limited by the unutilized surface area of the combustion chamber surface 55. In the non-limiting example illustrated in FIG. 3 in which the spark plug boss 114 and the fuel injector boss are centrally located, the valves 110A-D may be arranged between the cylinder wall 118 and the spark plug and fuel injector bosses 114, 116. Thus, the size of the spark plug and fuel injector bosses 114, 116 and the size of the combustion chamber 60 and combustion chamber surface 55 (for example, cylinder diameter D_{c}) may limit the maximum size of the valves 110A-D and ports 112A-D. Furthermore, the size of the spark plug boss 114 and the fuel injector boss 116 may be dependent on the size of their associated spark plug (not shown) and fuel injector 28, respectively, which may be relatively constant across all engine sizes.

In the non-limiting example illustrated in FIG. 3, the first valve 110A is arranged between the spark plug boss 114 and the cylinder wall 118 on the first side of the combustion chamber surface 55. The second valve 110B is arranged between the fuel injector boss 116 and the cylinder wall 118 on the second side of the combustion chamber surface 55 opposite the first side. The spark plug boss 114 may be larger than the fuel injector boss 116 and, therefore, the surface area of the combustion chamber surface 55 available for the first valve 110A and first port 112A may be smaller than the surface area of the combustion chamber surface 55 available for the second valve 110B and second port 112B such that an asymmetric valve configuration may be utilized.

An asymmetric valve configuration may include different sizes for each valve and/or port in a set of either exhaust or intake valves and ports. As illustrated in FIG. 3, the second surface area Aᵥ₂ and the second diameter Dᵥ₂ of the second valve 110B may be greater than the first surface area Aᵥ₁ and the first diameter Dᵥ₁ of the first valve 110A, respectively. Similarly, the second cross-sectional area Aₚ₂ and the second diameter Dₚ₂ of the second port 112B may be greater than the first cross-sectional area Aₚ₁ and the first diameter Dₚ₁ of the first port 112A, respectively.

By way of non-limiting example, the second surface area Aᵥ₂ of the second valve 110B may be at least ten percent, and more specifically between fifteen and twenty percent, greater than the first surface area Aᵥ₁ of the first valve 110A. Similarly, the second cross-sectional area Aₚ₂ of the second port 112B may be at least ten percent, and more specifically between fifteen and twenty percent, greater than the first cross-sectional area Aₚ₁ of the first port 112A. Further, the second diameter Dᵥ₂ of the second valve 110B may be at least five percent, and more specifically between six and ten percent, greater than the first diameter Dᵥ₁ of the first valve 110A. Similarly, the second diameter Dₚ₂ of the second port 112B may be at least five percent, and more specifically between six and ten percent, greater than the first diameter Dₚ₁ of the first port 112A.

For example only, for a cylinder diameter D_{c} of approximately 74 millimeters, the first diameter Dᵥ₁ of the first valve 110A (and/or the first diameter Dₚ₁ of the first port 112A) may be approximately 24 millimeters and the second diameter Dᵥ₂ of the second valve 110B (and/or the second diameter Dₚ₂ of the second port 112B) may be approximately 26 millimeters. In a further non-limiting example, for a cylinder diameter D_{c} of approximately 74 millimeters, the first diameter Dₚ₁ of the first port 112A may be approximately 24 millimeters and the second diameter Dₚ₂ of the second port 112B may be approximately 26 millimeters.

What is claimed is:

1. An engine assembly comprising:
an engine structure defining a combustion chamber and first and second exhaust ports in communication with the combustion chamber;
a first valve arranged within the first exhaust port and having a first surface area; and
a second valve arranged within the second exhaust port and having a second surface area greater than the first surface area.

2. The engine assembly of claim 1, wherein the engine structure includes a combustion chamber surface that includes a spark plug boss and a fuel injector boss that are arranged centrally on the combustion chamber surface.

3. The engine assembly of claim 2, wherein the spark plug boss has a first center point, the fuel injector boss has a second center point and the combustion chamber surface has a third center point, the first center point being offset from the third center point by a first offset and the second center point being offset from the third center point by a second offset.

4. The engine assembly of claim 3, wherein the second offset is greater than the first offset.

5. The engine assembly of claim 4, wherein the first valve has a first diameter and the second valve has a second diameter that is at least 5 percent greater than the first diameter.

6. The engine assembly of claim 5, wherein the second surface area is at least 10 percent greater than the first surface area.

7. The engine assembly of claim 4, wherein the second surface area is at least 10 percent greater than the first surface area.

8. The engine assembly of claim 1, wherein the first valve has a first diameter and the second valve has a second diameter that is at least 5 percent greater than the first diameter.

9. The engine assembly of claim 8, wherein the second surface area is at least 10 percent greater than the first surface area.

10. The engine assembly of claim 9, wherein the second surface area is at least 10 percent greater than the first surface area.

11. A cylinder head comprising:
a combustion chamber surface;
a first exhaust port defined in the combustion chamber surface and having a first cross-sectional area; and
a second exhaust port defined in the combustion chamber surface and having a second cross-sectional area greater than the first cross-sectional area.

12. The cylinder head of claim 11, wherein the combustion chamber surface includes a spark plug boss and a fuel injector boss that are arranged centrally on the combustion chamber surface.

13. The cylinder head of claim 2, wherein the spark plug boss has a first center point, the fuel injector boss has a second center point and the combustion chamber surface has a third center point, the first center point being offset from the third center point by a first offset and the second center point being offset from the third center point by a second offset.

14. The cylinder head of claim 13, wherein the second offset is greater than the first offset.

15. The cylinder head of claim 14, wherein the first exhaust port has a first diameter and the second exhaust port has a second diameter that is at least 5 percent greater than the first diameter.

16. The cylinder head of claim 15, wherein the second cross-sectional area is at least 10 percent greater than the first cross-sectional area.

17. The cylinder head of claim 14, wherein the second cross-sectional area is at least 10 percent greater than the first cross-sectional area.

18. The cylinder head of claim 11, wherein the first exhaust port has a first diameter and the second exhaust port has a second diameter that is at least 5 percent greater than the first diameter.

19. The cylinder head of claim 18, wherein the second cross-sectional area is at least 10 percent greater than the first cross-sectional area.

20. The cylinder head of claim 19, wherein the second cross-sectional area is at least 10 percent greater than the first cross-sectional area.
